(19) United States
(12) Patent Application Publication
(10) Pub. No.: US 2020/0017310 A1
(43) Pub. Date: Jan. 16, 2020

(54) PRINTING MACHINE WITH CONVEYOR BELTS FOR CONVEYING SHEETS

(71) Applicant: HEIDELBERGER DRUCKMASCHINEN AG, Heidelberg (DE)

(72) Inventor: MARKUS MOEHRINGER, WEINHEIM (DE)

(21) Appl. No.: 16/442,744

(22) Filed: Jun. 17, 2019

(30) Foreign Application Priority Data
Jul. 16, 2018 (DE) 102018211782.9

(51) Int. Cl. B65G 47/26; B65G 47/91; B65G 39/18

(52) U.S. Cl. CPC B65G 47/265; B41J 11/007; B65G 39/18; B65G 47/915

(57) ABSTRACT

A printing machine includes a first conveyor belt and a downstream second conveyor belt for transporting sheets. A guide element is disposed between the conveyor belts to guide the sheets. A blower device is provided to lift a leading edge of a respective sheet in a region of transition from the first conveyor belt to the guide element.

### CROSS-REFERENCE TO RELATED APPLICATION

This application claims the priority, under 35 U.S.C. § 119, of German Patent Application DE 10 2018 211 782.9, filed Jul. 16, 2018; the prior application is herewith incorporated by reference in its entirety.

### BACKGROUND OF THE INVENTION

### Field of the Invention

The present invention relates to a printing machine including a first conveyor belt and a downstream second conveyor belt for transporting sheets as well as an intermediate guide element provided therebetween to guide the sheets.

German Publication DE 10 2005 055 364 A1, corresponding to U.S. Pat. No. 7,597,325, describes a printing machine that includes conveying modules with suction belts. A guide device formed by two rollers is disposed between two neighboring conveying modules. The publication shows that the sheet protrudes beyond the first suction belt when its leading edge reaches the nip between the two rollers. Fragile sheets such as paper sheets cannot protrude in such a way. That is only possible for more rigid sheets, e.g. cardboard sheets.

### SUMMARY OF THE INVENTION

It is accordingly an object of the invention to provide a printing machine with conveyor belts for conveying sheets, which overcomes the hereinafore-mentioned disadvantages of the heretofore-known devices of this general type and which is suitable for fragile sheets.

With the foregoing and other objects in view there is provided, in accordance with the invention, a printing machine, comprising a first conveyor belt and a downstream second conveyor belt for transporting sheets, a guide element disposed therebetween for the sheets and a blower device for lifting a leading edge of a respective sheet in a region of transition from the first conveyor belt to the guide element.

An advantage of the printing machine of the invention is that the blower device reliably prevents the leading edge from colliding with the guide element.

Therefore, the printing machine of the invention is not only suitable for rigid sheets but also for fragile sheets.

Various further developments are possible.

The blower device may be disposed upstream of the guide element in terms of the direction of transport of the sheets.

The blower device may be disposed within a path of revolution of the first conveyor belt.

The first conveyor belt may have a perforation and the blower device may blow onto the respective sheet through the perforation.

A valve may be provided to activate the blower device in accordance with the cycle of transport of the sheets.

The valve may be a rotary valve. The rotary valve may be driven by a servomotor. When the first conveyor belt and the second conveyor belt are at a constant speed, the rotary valve may be driven at a non-uniform speed.

The printing machine may be a digital printing machine, in particular a printing machine for inkjet printing. The guide element may be or may include a guide plate.

The first conveyor belt and/or the second conveyor belt may be a vacuum belt.

Advantageous further developments of the invention will become apparent from the following description of two exemplary embodiments and the associated drawing.

Other features which are considered as characteristic for the invention are set forth in the appended claims.

Although the invention is illustrated and described herein as embodied in a printing machine with conveyor belts for conveying sheets, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A is a fragmentary, diagrammatic, side-elevational view of a sheet-transporting device including a first conveyor belt and a second conveyor belt during a first phase of motion in which the first conveyor belt transports a sheet to a guide element;

FIG. 1B is a fragmentary, top-plan view of the sheet-transporting device in the first phase of motion shown in FIG. 1A;

FIG. 2A is a fragmentary, side-elevational view which illustrates the sheet-transporting device in a following second phase of motion in which the sheet conveyed by the first conveyor belt is pneumatically lifted above the guide element by a blower device;

FIG. 2B is a fragmentary, top-plan view of the sheet-transporting device in the second phase of motion shown in FIG. 2A.

FIG. 3A is a fragmentary, side-elevational view which illustrates the sheet-transporting device in a third phase of motion in which a leading section of the sheet is already being guided by the guide element while a trailing section continues to be transported by the first conveyor belt;

FIG. 3B is a fragmentary, top-plan view of the sheet-transporting device in the third phase of motion shown in FIG. 3A; and

FIG. 4 is an overall fragmentary, longitudinal-sectional view of an inkjet printing machine including the sheet-transporting device shown in FIGS. 1A to 3B.

### DETAILED DESCRIPTION OF THE INVENTION

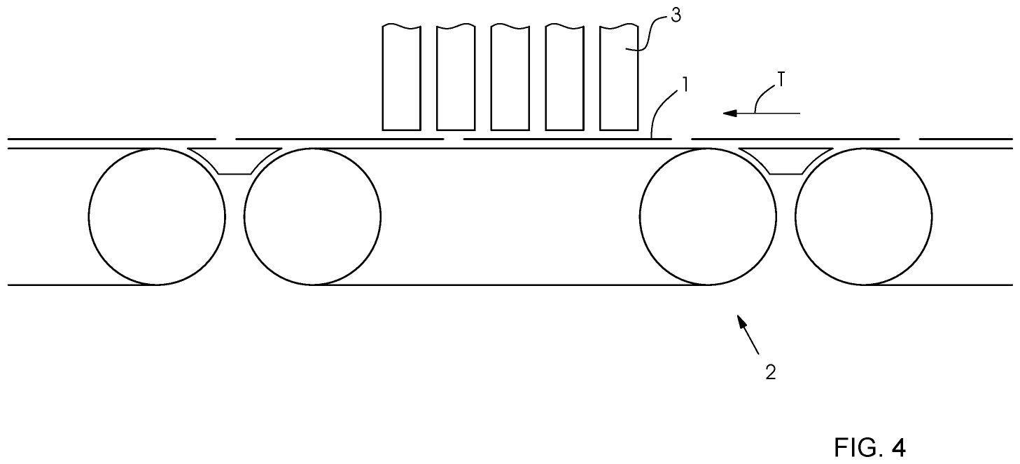

Referring now to the figures of the drawings in detail and first, particularly, to FIG. 4 thereof, there is seen a digital printing machine with a sheet conveyor 2 as the sheet-transporting device for conveying sheets 1 past inkjet print heads 3.

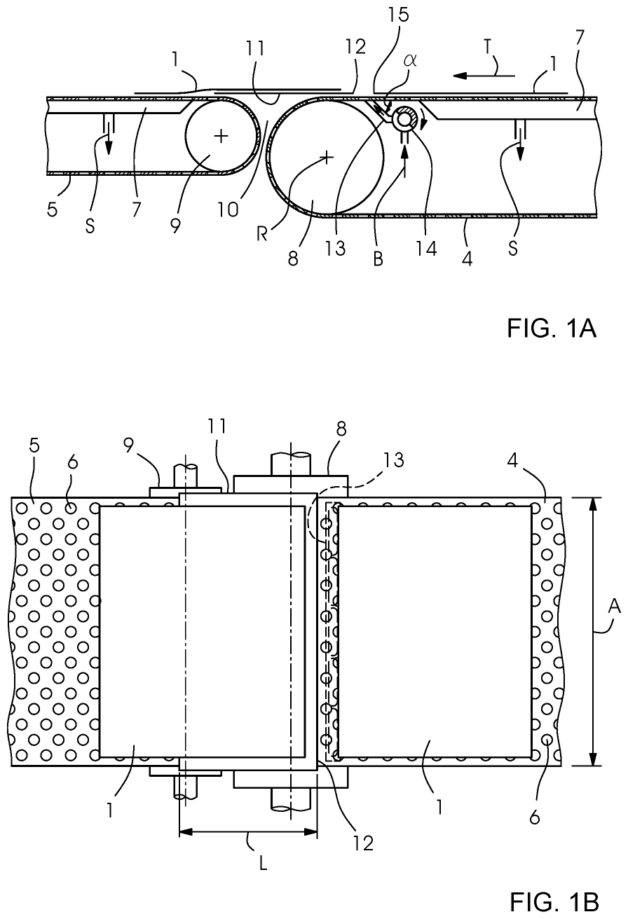

As is shown in FIGS. 1A to 3B, the belt conveyor 2 includes a first conveyor belt 4 and a second conveyor belt 5 following the first conveyor belt 4 in a direction of transport T. The two conveyor belts 4, 5 are suction belts or vacuum belts and have perforations 6 through which a suction box 7 holds the sheets 1 on the conveyor belts 4, 5 pneumatically. The respective suction box 7 has a suction air connection for connection with a vacuum source S, which is symbolically indicated by an arrow. Every conveyor belt 4, 5 has a width A that at least corresponds to the width of the maximum processable format of the sheets 1. In this context, the width of the two conveyor belts 4, 5 may be the same or different. Every conveyor belt 4, 5 runs over a minimum of two rollers 8, 9, one of which is a drive roller and the other of which is a deflection roller. The drawing only shows a front roller 8 of the first conveyor belt 4 and a rear roller 9 of the second conveyor belt 5 in terms of the direction of transport T. The two other rollers of the conveyor belts 4, 5 are not shown.

The upper transport strands or runs of the two conveyor belts 4, 5 are located in the same plane, i.e. they are coplanar. The lower return strands or runs may likewise be coplanar (as shown in FIG. 4) or they may be vertically offset relative to one another (as shown in FIG. 1A), i.e. plane-parallel. A wedge-shaped space 10, between the front roller 8 of the first conveyor belt 4 and the rear roller 9 of the second conveyor belt 5, is bridged by a guide element 11 for the sheets 1. The guide element 11 may be a guide sheet or a guide plate (FIG. 1A) or an air box with a cover plate acting as a guide plate (FIG. 4). In both alternatives, the guide element 11 has a flat guiding surface that is plane-parallel with the sheet-supporting outer surfaces of the conveyor belts 4, 5. A rear edge 12 of the guide element 11 is located above the outer surface of the transport strand or run of the first conveyor belt 4. In terms of the direction of transport T, the rear or trailing edge 12 of the guide element 11 is at least on the level of the axis of rotation R of the front roller 8 or, as shown, even upstream thereof.

A blower device 13 is disposed within a path of revolution of the first conveyor belt 4 and between the suction box 7 and the front roller 8. The blower device 13 extends over the entire width of the sheet 1 and may be constructed as a blow tube or blow bar. A protruding blow slit or row of blow holes 16 of the blower device 13 is oriented towards the inner surface of the transport strand or run of the first conveyor belt 4 and may be in contact with that inner surface. The blower device 13 has a blowing direction (shown by an arrow) that is oblique relative to the direction of transport T, preferably at an acute angle α. One component of the blowing direction is oriented in the direction of Transport T.

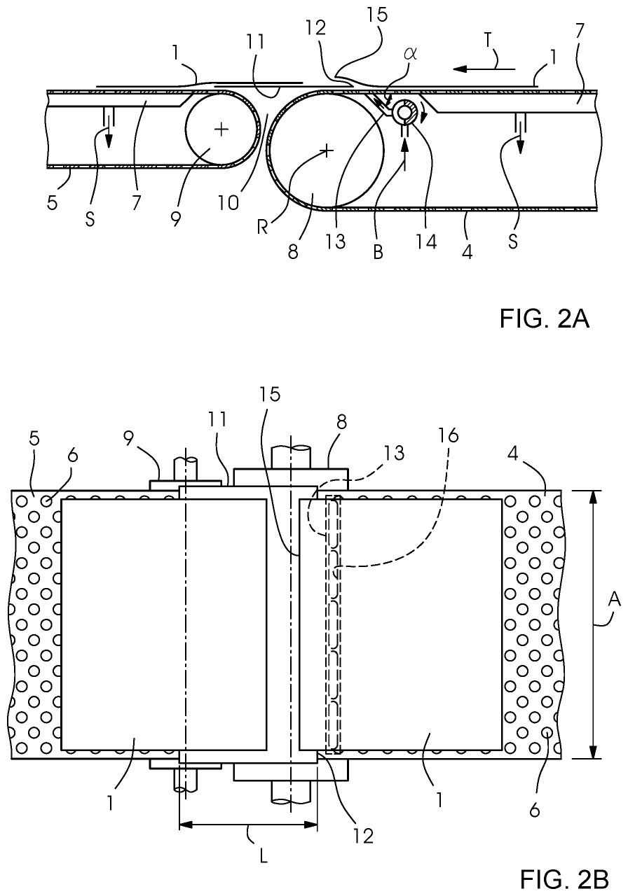

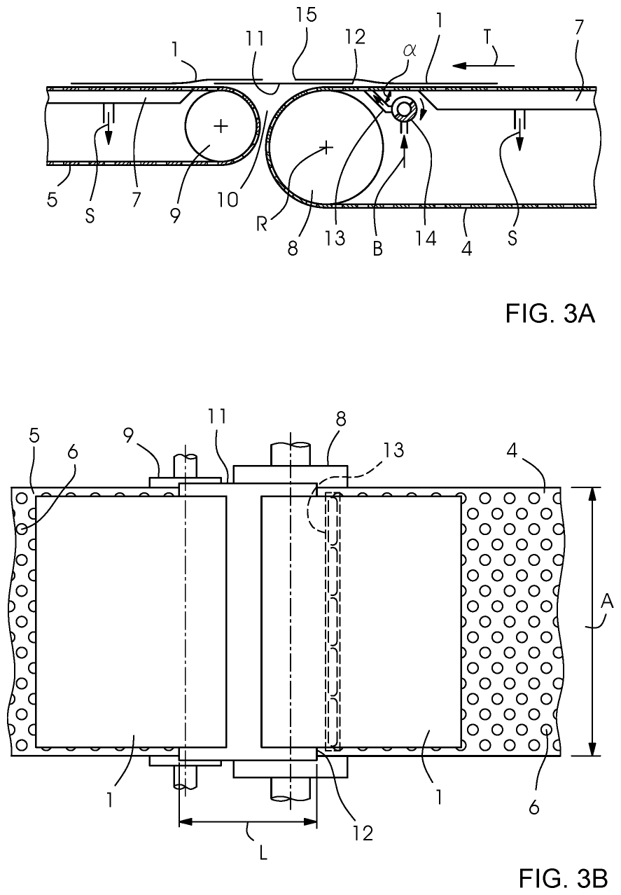

A valve 14 connects the blower device 13 to a blown-air source B. The valve 14 is controlled or constructed in such a way that it periodically causes the blower device 13 to emit a blast of air in accordance with the conveying cycle of the sheets 1. The valve 14 may be a magnetic valve or any other type of control valve, preferably a rotary valve as shown. The blower device 13 blows through the perforation 6 against the leading end of the sheet 1 in order to temporarily lift a leading edge 15 of the sheet 1 to a vertical level above the rear edge 12 of the guide element 11 as shown in FIG. 2A. In this process, the blast of air only lifts the leading end of the sheet 1 off the first conveyor belt 4 whereas the trailing section of the sheet 1 remains flat on the first conveyor belt 4. Lifting off the leading sheet end prevents a collision between the leading edge 15 of the sheet 1 moving in the direction of transport T and the rear edge 12 of the guide element 11 to ensure that the sheet 1 slides onto the guide element 11 without any kinks or the like, i.e. without damage, as shown in FIG. 3A.

Measured in the direction of transport T, the guide element 11 has a length L that is shorter than the length of every treatable format, i.e. even shorter than the minimum format of the sheets 1. This ensures that the sheet 1 sliding on the guide element 11 is securely held by at least one conveyor belt ⅘ at all times, effectively preventing any uncontrolled movement. The length L is dimensioned in such a way that at the instant of being transferred from the first conveyor belt 4 to the second conveyor belt 5, the sheet 1 sliding on the guide element 11 is simultaneously in contact with both conveyor belts 4, 5, which attract the sheet by suction. The sheet 1 may slide on the guide element 11 either under immediate contact between the sheet 1 and the guide element 11 or—if the guide element 11 has blower nozzles for supporting the sheet 1—floating on a blown-air cushion.

The following is a summary list of reference numerals and the corresponding structure used in the above description of the invention:
1 sheet
2 belt conveyor
3 print head
4 first conveyor belt
5 second conveyor belt
6 perforation
7 suction box
8 front roller
9 rear roller
10 intermediate space
11 guide element
12 rear edge (of guide element 11)
13 blower device
14 valve
15 leading edge (of sheet 1)
16 blower opening
A width
B blown-air generator
L length
R axis of rotation
S suction air generator
T direction of transport
α angle

1. A printing machine, comprising:
a first conveyor belt and a second conveyor belt disposed downstream of said first conveyor belt for transporting sheets;
a guide element disposed between said first and second conveyor belts for guiding the sheets;
a transition region from said first conveyor belt to said guide element; and
a blower device disposed in said transition region for lifting a leading edge of a respective sheet.

2. The printing machine according to claim 1, wherein said blower device is disposed upstream of said guide element in a direction of transport of the sheets.

3. The printing machine according to claim 1, wherein said blower device is disposed within a path of revolution of said first conveyor belt.

4. The printing machine according to claim 1, wherein said first conveyor belt has a perforation and said blower device blows on said respective sheet through said perforation.

5. The printing machine according to claim 1, which further comprises a valve for activating said blower device in accordance with a transport cycle of the sheets.

6. The printing machine according to claim 5, wherein said valve is a rotary valve.

7. The printing machine according to claim 1, which further comprises at least one print head oriented towards said first conveyor belt for inkjet printing.

8. The printing machine according to claim 1, wherein said guide element is a guide plate or includes a guide plate.

9. The printing machine according to claim 1, wherein said first conveyor belt is a vacuum belt.

10. The printing machine according to claim 1, wherein said second conveyor belt is a vacuum belt.
